(19) United States
(12) Patent Application Publication
(10) Pub. No.: US 2018/0137212 A1
(43) Pub. Date: May 17, 2018

(54) DEVICE DESIGN SUPPORT APPARATUS, DEVICE DESIGN SUPPORT METHOD AND DEVICE DESIGN SUPPORT SYSTEM

(71) Applicant: HITACHI, LTD., Tokyo (JP)

(72) Inventors: Yuhua ZHANG, Tokyo (JP); Tetsufumi KAWAMURA, Tokyo (JP); Atsushi ISOBE, Tokyo (JP); Nobuyuki SUGII, Tokyo (JP); Daisuke RYUZAKI, Tokyo (JP)

(73) Assignee: HITACHI, LTD., Tokyo (JP)

(21) Appl. No.: 15/806,803

(22) Filed: Nov. 8, 2017

(30) Foreign Application Priority Data
Nov. 11, 2016 (JP) 2016-220319

(51) Int. Cl. G06F 17/50

(52) U.S. Cl. CPC G06F 17/50; G06F 2217/12; G06F 17/5018; G06F 17/5009

(57) ABSTRACT

Provided is a device design support apparatus in which a data input-output portion receives an input of a first device provisional specification relating to a device from a customer, a database generating portion generates a second database based on a first database stored in a database storing portion and the first device provisional specification, and a device specification generating portion generates a second device provisional specification relating to the device based on the second database, presents the second device provisional specification to the customer by outputting the generated second device provisional specification through the data input-output portion, receives the input of a change content of the second device provisional specification from the customer, and generates a device fixed specification of the device based on the second device provisional specification and the change content.

### BACKGROUND OF THE INVENTION

### Field of the Invention

The present invention relates to a device design support apparatus, a device design support method, and a device design support system.

### Background Art

For example, in a process of manufacturing a device such as micro electro mechanical systems (MEMS) mounted in a sensor, first, a specification of the device is determined based on a sensor specification which is demanded by a customer. Therefore, the device is manufactured via device design relating to a material or a structure, circuit design, manufacturing process design, package design, and the like. If the manufactured device does not satisfy the specification of the sensor, the processes are repeatedly performed.

In the manufacturing of the device, the device may be manufactured by using a databases of an existing product. In this case, first, a part configuring the device is searched from the database of the existing product, based on the sensor specification presented from the customer. Therefore, the device is manufactured by using the searched part. If the manufactured device does not satisfy the specification of the sensor, a use of another part which becomes a substitute is examined. In the database of the existing product, numerous device models are registered. In order to achieve efficiency of work, a design support apparatus is used.

For example, JP-A-2002-324088 discloses a design support apparatus of a construction in which an initial shape for optimization calculation is automatically made from a three-dimensional CAD model of the construction designed in the past, and a design variable, an upper limit value and a lower limit value thereof are capable of being easily calculated and determined.

US Patent Application Publication No. 2009/0210350 discloses a method for optimizing a price and delivery time, by receiving a demand specification of a customer, referring to a database relating to the customer, a plant, and design, and selecting a design specification while performing ranking such as the price.

### SUMMARY OF THE INVENTION

Generally, in the manufacturing process of the device, the detailed design of each portion is performed after the design of the whole device is performed. Therefore, fitting and redesign are repeated until the specification demanded by the customer is satisfied, and a lot of time is taken until the final product is completed.

In the manufacturing process of the device, in a case where the database of the existing product is used, for example, there is a case where the design or the manufacturing is not possible such that the suitable device model does not exists. Additionally, there is a case where it is not possible to extract the device model from the existing product database since the specification of the new product is not clear such that the customer oneself does not grasp the specification. Since the model extraction from the existing product database is performed based on an intuition or an experience of a designer, an intention of the customer is not sufficiently reflected in the manufacturing process. In this case, a lot of time is taken until the final product is completed.

An object of the present invention is to provide a device design support apparatus where a device specification to which an intention of a customer is reflected is early fixed.

If a representative outline of the invention disclosed in the present application is simply described, the description thereof is as follows.

According to an aspect of the present invention, there is provided a device design support apparatus including a data input-output portion that performs input-output of data, a database storing portion that stores a database configured with a plurality of device models relating to a device, a database generating portion that generates the database, and a device specification generating portion that generates a device specification of the device, in which the data input-output portion receives an input of a first device provisional specification relating to the device from a customer, the database generating portion generates a second database based on a first database stored in the database storing portion and the first device provisional specification, and the device specification generating portion generates a second device provisional specification relating to the device based on the second database, presents the second device provisional specification to the customer by outputting the generated second device provisional specification through the data input-output portion, receives the input of a change content of the second device provisional specification from the customer, and generates a device fixed specification of the device based on the second device provisional specification and the change content.

If an effect obtained by a representative embodiment of the invention disclosed in the present application is simply described, the description thereof is as follows.

In other words, according to the representative embodiment of the present invention, it is possible to provide a device design support apparatus where a device specification to which an intention of a customer is reflected is early fixed.

### BRIEF DESCRIPTION OF THE DRAWINGS

FIG. 1 is a diagram illustrating an example of a configuration of a device design support system according to Embodiment 1 of the present invention.

FIG. 2 is a diagram illustrating an example of a configuration of a device design support apparatus according to Embodiment 1 of the present invention.

FIG. 3 is a diagram illustrating an example of a configuration of a first database according to Embodiment 1.

FIG. 4 is a flowchart illustrating an example of a process of determining a device fixed specification according to Embodiment 1 of the present invention.

FIG. 5 is a flowchart illustrating an example of the process of determining the device fixed specification according to Embodiment 1 of the present invention.

FIG. 6 is a diagram illustrating an example of an input screen of a customer demand specification according to Embodiment 1 of the present invention.

FIG. 7 is a diagram illustrating an example of a device specification which is extracted from the customer demand specification according to Embodiment 1 of the present invention.

FIG. 8 is a diagram illustrating an example of a configuration of a second intermediate database according to Embodiment 1 of the present invention.

FIG. 9 is a diagram illustrating a specific example of the second intermediate database according to Embodiment 1 of the present invention.

FIG. 10 is a diagram illustrating an example of an outline of a second device provisional specification which is presented to a customer according to Embodiment 1 of the present invention.

FIG. 11 is a diagram illustrating an example of details of the second device provisional specification according to Embodiment 1 of the present invention.

FIG. 12 is a diagram illustrating an example of evaluation of a device characteristic in the second device provisional specification according to Embodiment 1 of the present invention.

FIG. 13 is a flowchart illustrating an example of a simulation process according to Embodiment 1 of the present invention.

FIG. 14 is a flowchart illustrating an example of a process of determining a new device fixed specification according to Embodiment 2 of the present invention.

FIG. 15 is a flowchart illustrating an example of a process of determining a new device fixed specification according to Embodiment 3 of the present invention.

### DETAILED DESCRIPTION OF THE INVENTION

Hereinafter, embodiments of the present invention will be described in detail based on the drawings. In all drawings for describing the embodiments, the same sign is attached to the same portion in principle, and the repeated description thereof will be omitted. In the following description, a case where a design support relating to MEMS on which a sensor is mounted as an example of a device is performed, will be described.

### Embodiment 1

### Apparatus Configuration

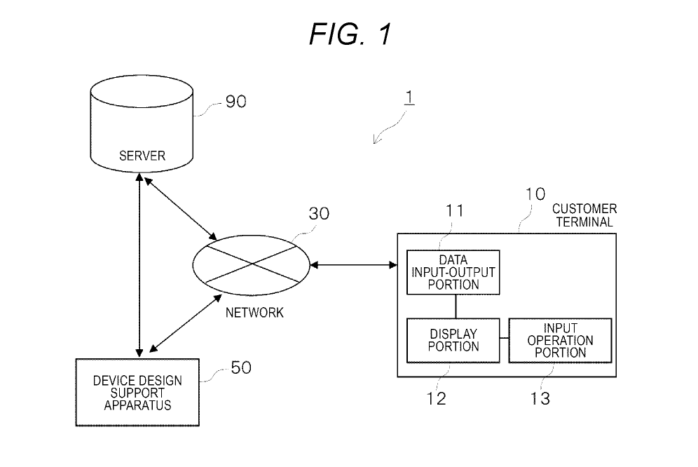

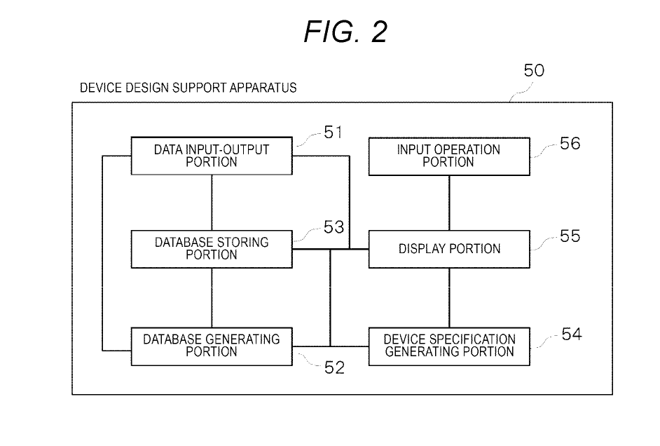

FIG. 1 is a diagram illustrating an example of a configuration of a device design support system according to Embodiment 1 of the present invention. FIG. 2 is a diagram illustrating an example of a configuration of a device design support apparatus according to Embodiment 1 of the present invention. For example, as illustrated in FIG. 1, a device design support system 1 includes a customer terminal 10, a network 30, a device design support apparatus 50, and the like. For example, as illustrated in FIG. 1, the device design support system 1 may include a server 90, in addition to the configuration elements. In the device design support system 1, for example, as illustrated in FIG. 1, the customer terminal 10, the device design support apparatus 50, and the server are connected to each other through the network 30. For example, as illustrated in FIG. 1, the device design support apparatus 50 and the server 90 may be directly connected to each other.

In the customer terminal 10, for example, an input of a device provisional specification (for example, a customer demand specification or the like) is performed by a customer. For example, as illustrated in FIG. 1, the customer terminal 10 includes a data input-output portion (customer side data input-output portion) 11, a display portion 12, an input operation portion 13, and the like. In the customer terminal 10, for example, the customer operates the input operation portion 13, with respect to a user interface such as a predetermined device provisional specification input screen (for example, a customer demand specification input screen described later) which is displayed on the display portion 12, thereby, a predetermined device provisional specification is input. The customer terminal 10 outputs the input device provisional specification to the device design support apparatus 50, for example, through the data input-output portion 11 and the network 30. The customer terminal 10 may output the input device provisional specification to the server 90. In this case, the output device provisional specification is stored in the server 90. For example, the customer terminal 10 receives the input of the device provisional specification which is generated in the device design support apparatus 50.

For example, the customer terminal 10 may be connected to the network 30 in a wired manner, or may be connected to the network 30 in a wireless manner through a wireless router or the like. For example, the customer terminal 10 may be disposed in the vicinity of the device design support apparatus 50, and may be directly connected to the device design support apparatus 50. For example, the customer terminal 10 may be configured integrally with the device design support apparatus 50. For example, the device provisional specification input screen described above may be displayed on a display portion 55 of the device design support apparatus 50 illustrated in FIG. 2, and the customer may operate an input operation portion 56, thereby, a predetermined device provisional specification may be input.

For example, as illustrated in FIG. 2, the device design support apparatus 50 includes a data input-output portion 51, a database generating portion 52, a database storing portion 53, a device specification generating portion 54, the display portion 55, the input operation portion 56, and the like. For example, the device design support apparatus 50 may be connected to the network 30 in a wired manner, or may be connected in a wireless manner through the wireless router or the like.

For example, the data input-output portion 51 is connected to the network 30 or the like illustrated in FIG. 1, and receives the input of the device provisional specification which is input from the customer terminal 10, through the network 30. The data input-output portion 51 outputs the device provisional specification or the like which is generated in the device specification generating portion 54, to the customer terminal 10. The data input-output portion 51 may output the device provisional specification, a device fixed specification, a database which is generated in the database generating portion 52, or the like, to the server 90. In this case, the output device provisional specification, the output device fixed specification, the output database, or the like are stored in the server 90.

For example, the database generating portion 52 generates the database (for example, a first database or the like) of a device model based on the device provisional specification which is input from the customer. Details regarding the generation of the database will be described later. The database generating portion 52 outputs the generated database, for example, to the database storing portion 53. The database generating portion 52 may output the generated database to the server 90 through the data input-output portion 51. The database generating portion 52 generates various kinds of databases such as a first intermediate database, a second intermediate database, an individual database (second database), and a device fixed specification database described later.

The database storing portion 53 stores the database relating to the device model. The database storing portion 53 stores the database (first database) that is configured with a lot of device models of an existing product relating to the device or a part of the device, the database which is generated in the database generating portion 52 described above, and the like. The database storing portion 53 may store the device provisional specification, the device fixed specification, or the like which is generated in the device specification generating portion 54.

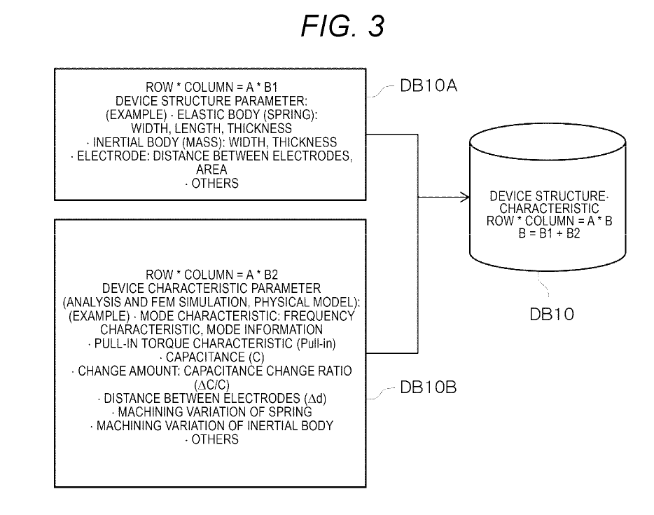

FIG. 3 is a diagram illustrating an example of a configuration of the first database according to Embodiment 1. For example, as illustrated in FIG. 3, a first database DB10 includes a device structure parameter DB10A, and a device characteristic parameter DB10B. The device structure parameter DB10A includes the device structure parameter per device model. For example, as illustrated in FIG. 3, the device structure parameter DB10A includes the parameter of each item such as a width, a length, or a thickness of an elastic body (for example, a spring or the like) of the existing product. For example, as illustrated in FIG. 3, the device structure parameter DB10A includes the parameter of each item such as the width or the thickness of an inertial body (mass) of the existing product. For example, as illustrated in FIG. 3, the device structure parameter DB10A accumulates the parameter of each item such as an area of an electrode of the existing product or a distance between the electrodes facing each other. In addition to the items, the device structure parameter DB10A accumulates various kinds of parameters relating to a device structure of the existing product. The device structure parameter DB10A may store the device structure parameter of the device model which is not productized.

On the other hand, the device characteristic parameter DB10B includes the device characteristic parameter per device model. For example, as illustrated in FIG. 3, the device characteristic parameter DB10B includes an analysis with respect to each device structure parameter which is included in the device structure parameter DB10A, a simulation by a finite element method (FEM), or a calculation result by an expression of a physical model, as a device characteristic parameter. For example, as illustrated in FIG. 3, the device characteristic parameter DB10B includes the parameter relating to a mode characteristic such as a frequency characteristic or mode information of the existing product.

For example, as illustrated in FIG. 3, the device characteristic parameter DB10B accumulates the parameter relating to a pull-in torque characteristic of the existing product. For example, as illustrated in FIG. 3, the device characteristic parameter DB10B includes the parameter relating to a change amount (ΔC) of capacitance of the existing products, or a change amount (Δd) of the distance between the electrodes. In addition to the items, the device characteristic parameter DB10B includes the parameters of various kinds of device characteristics with respect to the parameter of the device structure of the existing product. The device characteristic parameter DB10B may include the device characteristic parameter of the device model which is not productized.

The device specification generating portion 54 generates the device provisional specification (second device provisional specification or the like) which is presented to the customer, based on the device provisional specification (first device provisional specification or the like) or the database which is input from the customer. The device specification generating portion 54 determines an evaluation factor for cluster analysis, based on the device provisional specification which is input from the customer. The device specification generating portion 54 performs a cluster analysis with respect to the first intermediate database described later, by the evaluation factor for cluster analysis. The device specification generating portion 54 performs weighting of the evaluation factor based on a result of the cluster analysis. The details of the weighting of the evaluation factor will be described later. The device specification generating portion 54 performs ranking of the device model per evaluation factor, based on the result of the cluster analysis, and generates ranking data of the device model per evaluation factor. The details of the ranking of the device model per evaluation factor will be described later.

The device specification generating portion 54 selects a plurality of evaluation factors of which rankings are high, based on the weighting of the evaluation factor, and generates a plurality of evaluation factor combinations for the individual database (second database) described later, from the selected evaluation factor. The device specification generating portion 54 generates a third device provisional specification by updating the second device provisional specification which is presented to the customer, based on the second device provisional specification and a change content of the device specification which is input from the customer. The device specification generating portion 54 generates the device fixed specification based on the third device provisional specification and a supplement content from the customer.

For example, the display portion 55 displays the device provisional specification which is output from the customer terminal 10, the database which is generated in the database generating portion 52, the device provisional specification which is generated in the device specification generating portion 54, the device fixed specification, and the like. The display portion 55 displays an input screen or the like relating to the generation of the database, the device provisional specification, and the device fixed specification. The display portion 55 displays various kinds of information such as a setting screen, setting information, an operation situation, and the like of the device design support apparatus 50. Various kinds of data from the input operation portion 56, is input to the input screen or the setting screen which is displayed on the display portion 55.

The server 90 stores various kinds of information such as the device provisional specification described above, the device fixed specification, and the database. The server 90 outputs various kinds of information such as the stored device provisional specification, the stored device fixed specification, and the stored database to the device design support apparatus 50 and the customer terminal 10, for example, in accordance with the demand from the device design support apparatus 50.

### Device Design Support Method

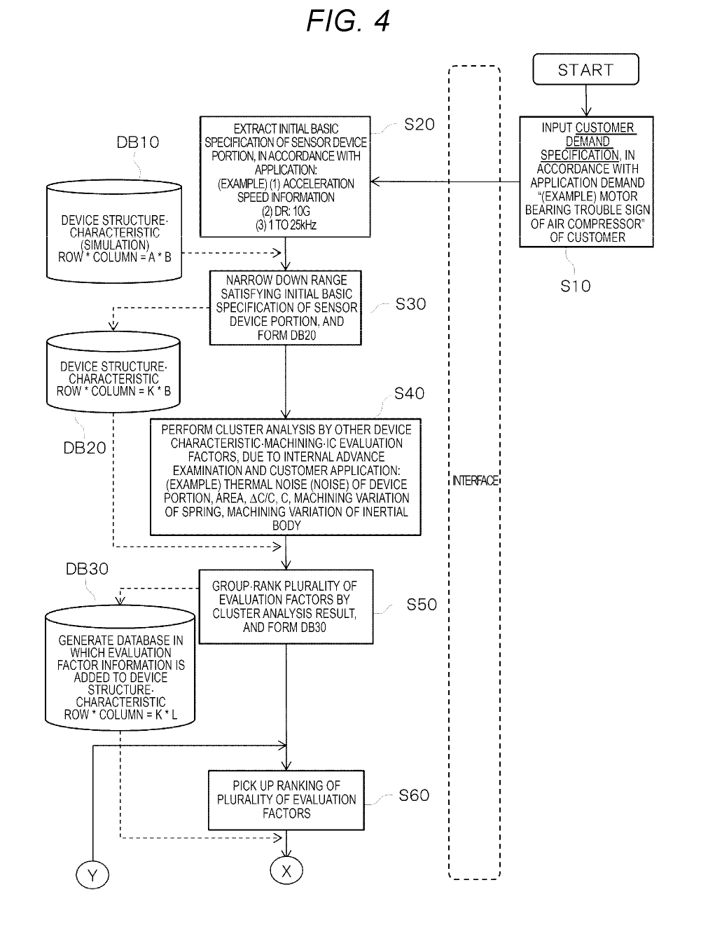

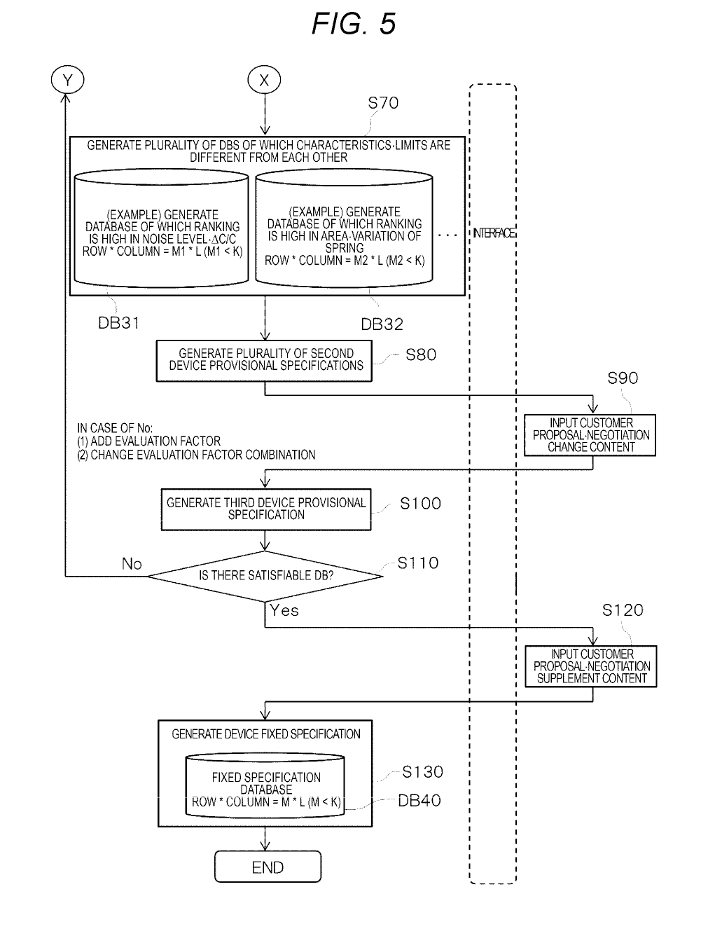

Next, a device design support method using the device design support system 1 and the device design support apparatus 50 according to Embodiment 1, will be described. The device design is configured by a process of determining the device fixed specification, and a simulation process of determining whether or not variation of the device characteristic parameter in the device fixed specification belongs to an allowable range of the device fixed specification. First, the process of determining the device fixed specification will be described. FIGS. 4 and 5 are flowcharts illustrating an example of the process of determining the device fixed specification according to Embodiment 1 of the present invention. In order to determine the device fixed specification, processing is respectively performed, in steps S10 to S130 illustrated in FIGS. 4 and 5.

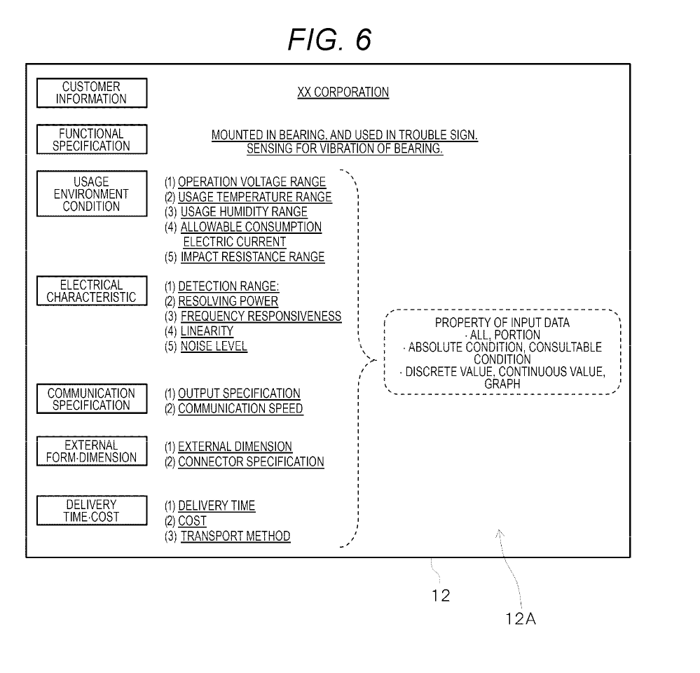

First, in step S10 of FIG. 4, the customer inputs the customer demand specification as a first device provisional specification, by using the customer terminal 10. FIG. 6 is a diagram illustrating an example of the input screen of the customer demand specification according to Embodiment 1 of the present invention. For example, as illustrated in FIG. 6, the customer inputs the data which is necessary as a customer demand specification, while referring to a customer demand specification input screen 12A which is displayed on the display portion 12 of the customer terminal 10.

For example, as illustrated in FIG. 6, the customer inputs corporate name of oneself, or the like as customer information, into a “customer information” column of the customer demand specification input screen 12A. For example, as illustrated in FIG. 6, the customer inputs the information relating to a function of the device such as “mounted in bearing, and used in trouble sign. sensing for vibration of bearing”, into a “functional specification” column of the customer demand specification input screen 12A. For example, as illustrated in FIG. 6, the customer inputs the specifications such as an operation voltage range, a usage temperature range, a usage humidity range, an allowable consumption electric power, and an impact resistance range of the device, into a “usage environment condition” column of the customer demand specification input screen 12A. For example, as illustrated in FIG. 6, the customer inputs the specifications such as a detection range, resolving power, frequency responsiveness, linearity, and a noise level of the device, into an “electrical characteristic” column of the customer demand specification input screen 12A. For example, as illustrated in FIG. 6, the customer inputs the specifications such as an output specification of the device and a communication speed, into a “communication specification” column of the customer demand specification input screen 12A. For example, as illustrated in FIG. 6, the customer inputs the specifications such as an external dimension and a connector specification of the device, into an “external form⋅dimension” column of the customer demand specification input screen 12A. For example, as illustrated in FIG. 6, the customer inputs the specifications such as delivery time, a cost, or a transport method of the device, into a “delivery time⋅cost” column of the customer demand specification input screen 12A. The customer terminal 10 outputs the input customer demand specification to the device design support apparatus 50, through the data input-output portion 11 and the network 30.

In the customer demand specification input screen 12A, the specifications may be input into all items, or the specifications may be input only into a portion of the items. For example, as illustrated in FIG. 6, an absolute condition which inevitably ought to satisfy the specification, and a consultable condition which may change the specification depending on the circumstance may be input into the customer demand specification input screen 12A. A discrete value, a continuous value, or a graph may be input as a range of condition⋅characteristic, into the customer demand specification input screen 12A.

In step S20 of FIG. 4, the device design support apparatus 50 extracts an initial basic specification of the device based on the customer demand specification which is output from the customer terminal 10. First, the data input-output portion 51 receives the input of the customer demand specification which is output from the customer terminal 10. The data input-output portion 51 outputs the input customer demand specification, for example, to the device specification generating portion 54. Therefore, the device specification generating portion 54 extracts, for example, a sensor initial basic specification, an integrated circuit (IC) initial basic specification, a package initial basic specification, or the like, based on the customer demand specification.

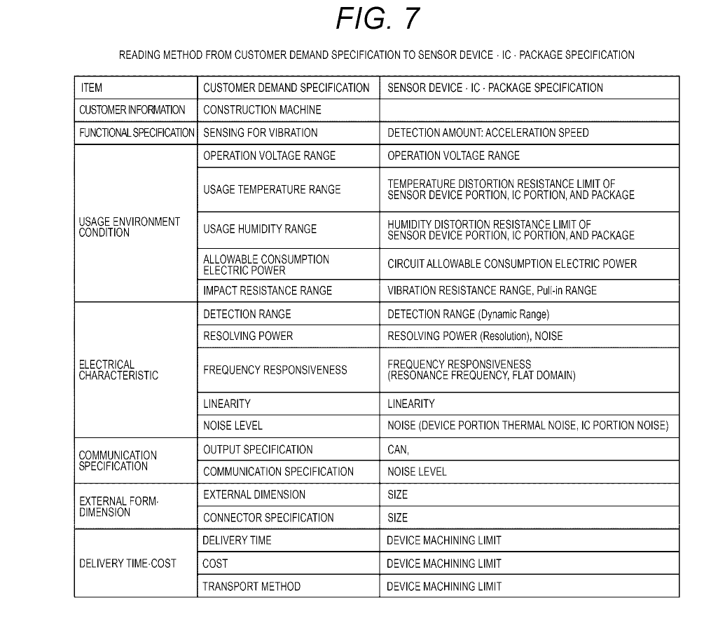

FIG. 7 is a diagram illustrating an example of the device specification which is extracted from the customer demand specification according to Embodiment 1 of the present invention. For example, as illustrated in FIG. 7, the device specification generating portion 54 extracts a detection amount (for example, an acceleration speed or the like), from the “functional specification” column of the customer demand specification. For example, as illustrated in FIG. 7, the device specification generating portion 54 extracts the operation voltage range of the device, from the “usage environment condition” column. For example, as illustrated in FIG. 7, the device specification generating portion 54 extracts a temperature distortion resistance limit of the sensor, the IC, or the package corresponding to the usage temperature range, from the “usage environment condition” column. For example, as illustrated in FIG. 7, the device specification generating portion 54 extracts a humidity distortion resistance limit of the sensor, the IC, or the package corresponding to the usage humidity range, from the “usage environment condition” column. For example, as illustrated in FIG. 7, the device specification generating portion 54 extracts a circuit allowable consumption electric power corresponding to the allowable consumption electric power, from the “usage environment condition” column. For example, as illustrated in FIG. 7, the device specification generating portion 54 extracts a vibration resistance range or a pull-in torque range corresponding to the impact resistance range, from the “usage environment condition” column.

For example, as illustrated in FIG. 7, the device specification generating portion 54 extracts the detection range (Dynamic Range, for example, 10G) of the device corresponding to the detection range, from the “electrical characteristic” column. For example, as illustrated in FIG. 7, the device specification generating portion 54 extracts the resolving power (resolution) of the device corresponding to the resolving power, from the “electrical characteristic” column. For example, as illustrated in FIG. 7, the device specification generating portion 54 extracts the frequency responsiveness (for example, a resonance frequency or a flat domain) of the device corresponding to the frequency responsiveness, from the “electrical characteristic” column. For example, as illustrated in FIG. 7, the device specification generating portion 54 extracts the linearity (Nonlinearity) of the device corresponding to the linearity, from the “electrical characteristic” column. For example, as illustrated in FIG. 7, the device specification generating portion 54 extracts a thermal noise of the sensor or the noise level of the IC corresponding to the noise level, from the “electrical characteristic” column.

For example, as illustrated in FIG. 7, the device specification generating portion 54 extracts the communication specification which is mountable on the device such as a controller area network (CAN) corresponding to the output specification, from the “communication specification” column. For example, as illustrated in FIG. 7, the device specification generating portion 54 extracts the noise level corresponding to the communication speed, from the “communication specification” column. For example, as illustrated in FIG. 7, the device specification generating portion 54 extracts a size of the device corresponding to the external dimension, from the “external form⋅dimension” column. For example, as illustrated in FIG. 7, the device specification generating portion 54 extracts the size of the connector corresponding to the connector specification, from the “external form⋅dimension” column. For example, as illustrated in FIG. 7, the device specification generating portion 54 extracts a device machining limit corresponding to each of the delivery time, the cost, and the transport method, from the “delivery time⋅cost” column. Here, for example, the device machining limit is referred to as an allowable range of manufacturing variation of the device.

For example, the device specification generating portion 54 extracts the evaluation factor such as the detection amount such as the acceleration speed in the “functional specification”, the detection range of the “electrical characteristic”, or the frequency responsiveness, as a sensor initial basic specification. The device specification generating portion 54 extracts the evaluation factor other than the evaluation factor described above, as an IC initial basic specification or a package initial basic specification. The device specification generating portion 54 may extract arbitrary evaluation factor as a sensor initial basic specification.

In a case where the data is input only into a portion of the evaluation factors in the evaluation factors described above of the customer demand specification, the device specification generating portion extracts only the specification which corresponds to the evaluation factor corresponding thereto. For example, the device specification generating portion 54 may output the sensor initial basic specification, the IC initial basic specification, or the package initial basic specification which is extracted from the customer demand specification, to the database storing portion 53 to be stored therein, or may output the sensor initial basic specification, the IC initial basic specification, or the package initial basic specification which is extracted from the customer demand specification, to a storing portion that is disposed within the device design support apparatus 50, and is not illustrated in the drawing to be stored therein. For example, the device specification generating portion 54 may output the initial basic specifications to the server 90 to be stored therein.

In step S30 of FIG. 4, the device design support apparatus 50 generates a first intermediate database DB20 described later, by referring to the first database DB10, and performing narrowing-down with respect to the first database DB10 based on the customer demand specification (first device provisional specification).

For example, the database generating portion 52 performs the narrowing-down with respect to the first database DB10, based on the sensor initial basic specification which is extracted in step S20. For example, the database generating portion 52 refers to the evaluation factor corresponding to the sensor initial basic specification in the parameters (the device structure parameter and the device characteristic parameter) which configure the first database DB10, and extracts the device (including a part) which satisfies the sensor initial basic specification. Therefore, the database generating portion 52 generates the first intermediate database DB20 including the device structure parameter and the device characteristic parameter which are associated with each device, regarding all of the extracted devices.

In step S40 of FIG. 4, the device design support apparatus 50 performs the cluster analysis with respect to the first intermediate database DB20, by the evaluation factor for cluster analysis. For example, the device specification generating portion 54 sets the items such as the thermal noise (noise level) of the sensor, the area of the electrode, the capacitance (C), a change ratio (ΔC/C) of the capacitance, the machining variation of the spring, and the machining variation of the inertial body, as an evaluation factor for cluster analysis. Therefore, the device specification generating portion 54 performs the cluster analysis with respect to the first intermediate database DB20 by the evaluation factors for cluster analysis. Specifically, the device specification generating portion 54 searches for the first intermediate database DB20, and classifies the parameters of all device models per evaluation factor. The device specification generating portion 54 performs such a classification of the parameters regarding all evaluation factors.

In step S50 of FIG. 4, the device design support apparatus 50 performs the weighting of the evaluation factor, by performing the weighting of the evaluation factor based on the result of the cluster analysis. For example, the device specification generating portion 54 performs the ranking of the evaluation factor in sequence from the evaluation factor which is considered to be important at the time of generating the device specification, in other words, the evaluation factor of which priority is high, with respect to each of the evaluation factors.

The device specification generating portion 54 performs the ranking of the device model per evaluation factor based on the result of the cluster analysis. For example, in a case where the device specification generating portion 54 performs the ranking regarding the device size, the ranking of the device model of which the device size is small is high, and the ranking of the device model of which the device size is large is low. For example, in a case where the device specification generating portion 54 performs the ranking regarding the thermal noise (noise level) of the sensor, the ranking of the device model of which the noise level is small is high, and the ranking of the device model of which the noise level is large is low. The device specification generating portion 54 performs such a ranking of the device model regarding all evaluation factors. Therefore, the device specification generating portion 54 generates the ranking data of the device model per evaluation factor. For example, the device specification generating portion outputs the generated ranking data to the database generating portion 52.

The device specification generating portion 54 may perform the weighting of the evaluation factor by other methods. For example, the device specification generating portion 54 may determine priority ranking based on a reference of the absolute condition or the consultable condition illustrated in FIG. 6, and may perform the weighting of the evaluation factor.

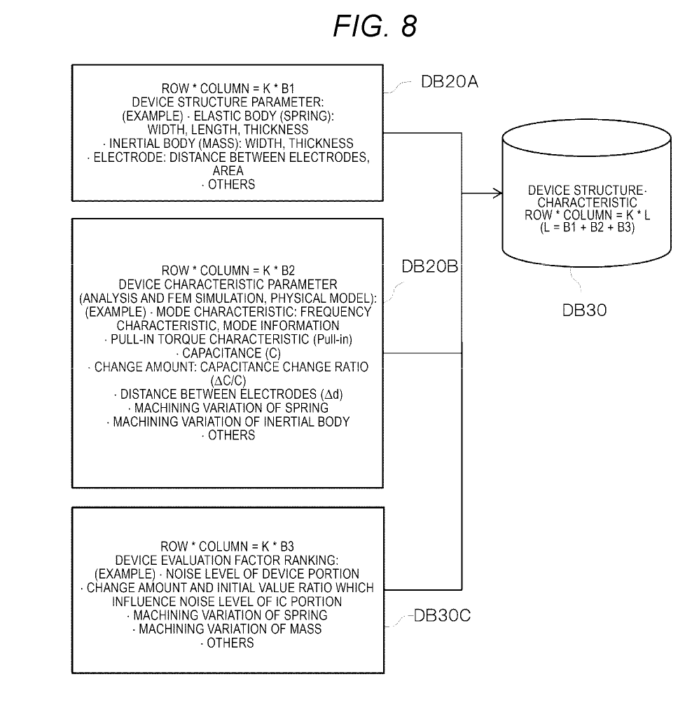

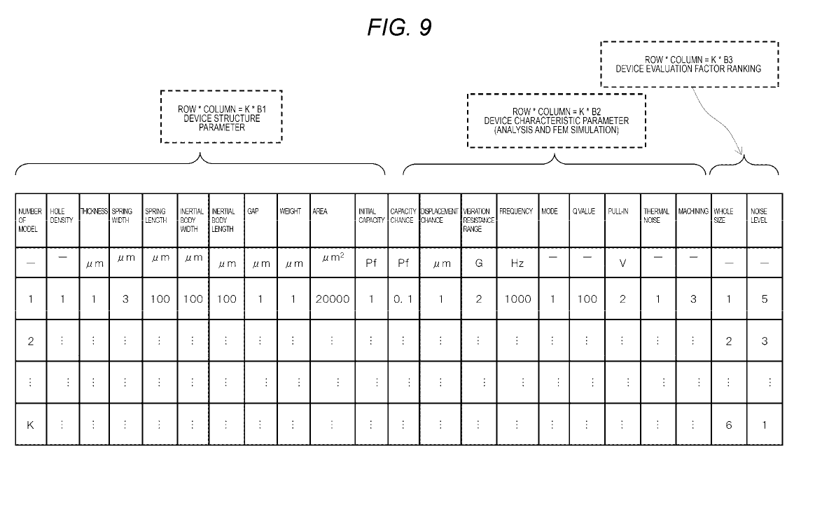

The database generating portion 52 generates the second intermediate database, based on the first intermediate database and the output ranking data. FIG. 8 is a diagram illustrating an example of a configuration of the second intermediate database according to Embodiment 1 of the present invention. FIG. 9 is a diagram illustrating a specific example of the second intermediate database according to Embodiment 1 of the present invention. For example, as illustrated in FIG. 8, the database generating portion 52 generates a device evaluation factor ranking DB30C which is configured with the ranking data per evaluation factor. Therefore, the database generating portion 52 generates a second intermediate database DB30, from the device structure parameter DB20A, the device characteristic parameter DB20B, and the device evaluation factor ranking DB30C configuring the first intermediate database DB20. In the second intermediate database DB30, for example, as illustrated in FIG. 9, the device structure parameter such as the thickness of the sensor, the width of the spring, or the length of the spring, the device characteristic parameter such as the change amount of the capacitance, the change amount of the distance between the electrodes, the vibration resistance range, or the operation frequency, and the device evaluation factor ranking such as the ranking relating to the device size or the ranking relating to the noise level are associated with each other per device. In FIG. 9, the device characteristic parameters and the device structure parameters of the device models which are subsequent to the second device model, are omitted.

For example, the database generating portion 52 may output the generated second intermediate database DB30 to the database storing portion 53 to be stored therein. For example, the database generating portion 52 may output the generated second intermediate database DB30 to the server 90 to be stored therein.

In step S60 of FIG. 4, the device specification generating portion 54 performs the ranking of the evaluation factor. For example, the device specification generating portion 54 performs the ranking of the evaluation factor in sequence from the evaluation factor of which priority is high at the time of determining the device specification, in the plurality of evaluation factors on which the cluster analyses are performed. For example, the device specification generating portion 54 sets the ranking of evaluation factor of which priority is high, such as the noise level the change ratio of the capacitance, the electrode area, or the machining variation of the spring which influences the performance of the sensor, to be high. On the contrary, for example, the device specification generating portion 54 sets the ranking of the evaluation factor which does not largely influence the performance of the sensor, to be low.

The device specification generating portion 54 selects the plurality of evaluation factors of which priorities are high, and generates the plurality of evaluation factor combinations for individual database described later, from the selected evaluation factors. For example, the device specification generating portion may generate the evaluation factor combination by combining two or more evaluation factors, or may generate the evaluation factor combination from only one evaluation factor. For example, the device specification generating portion 54 generates the plurality of evaluation factor combinations such as the combination of the noise level and the change ratio of the capacitance, and the combination of the electrode area and the machining variation of the spring. In addition thereto, the device specification generating portion 54 may generate the evaluation factor combination by combining the device size, the detection range of the sensor, and the like. Therefore, the device specification generating portion 54 outputs the generated evaluation factor combination, for example, to the database generating portion 52.

In step S70 of FIG. 5, the database generating portion 52 generates the individual database (second database) based on the evaluation factor combination which is output from the device specification generating portion 54. For example, the database generating portion 52 generates the individual database per evaluation factor combination, by searching for the second intermediate database DB30, and extracting the device model relating to the evaluation factor combination.

For example, the database generating portion 52 extracts the device model of which the noise level is small, and the change ratio of the capacitance is large, based on the evaluation factor combination obtained by combining the noise level and the change ratio of the capacitance. In detail, the database generating portion refers to the second intermediate database DB30, and extracts the device model of which the ranking of the noise level is within a predetermined ranking, and the ranking of the change ratio of the capacitance is within a predetermined ranking. Therefore, as illustrated in FIG. 5, the database generating portion 52 generates an individual database DB31 that is configured with the device model extracted by on the noise level and the change ratio of the capacitance. For example, the database generating portion 52 extracts the device model of which the electrode area is small, and the machining variation of the spring is small, based on the evaluation factor combination obtained by combining the electrode area and the machining variation of the spring. Therefore, as illustrated in FIG. 5, the database generating portion generates an individual database DB32 that is configured with the device model extracted by the electrode area and the machining variation of the spring. In this manner, in step S70, the database generating portion 52 generates a plurality of individual databases DB31, DB32, and the like of which the characteristics and the limits are different from each other. Therefore, the database generating portion 52 may output the generated individual database DB31, DB32, or the like, for example, to the database storing portion 53 or the server 90 to be stored therein.

The database generating portion 52 may generate the individual database based on the evaluation factor combination obtained by combining three or more evaluation factors. The database generating portion 52 may generate the individual database based on the evaluation factor combination which is configured with only one evaluation factor.

In step S80 of FIG. 5, the device specification generating portion 54 generates the second device provisional specification based on the individual database DB31, DB32, or the like which is generated in step S70. For example, the device specification generating portion generates a plurality of second device provisional specifications that are made in detail by updating the first device provisional specification based on the individual database DB31, DB32, or the like. For example, the device specification generating portion 54 generates the second device provisional specification which is excellent in noise level and change ratio of the capacitance, and the second device provisional specification which is excellent in electrode area and machining variation of the spring. At the time of generating the second device provisional specification, the device specification generating portion 54 may supplement the item of which the specification is not input from the customer, or may not supplement the item of which the specification is not input from the customer.

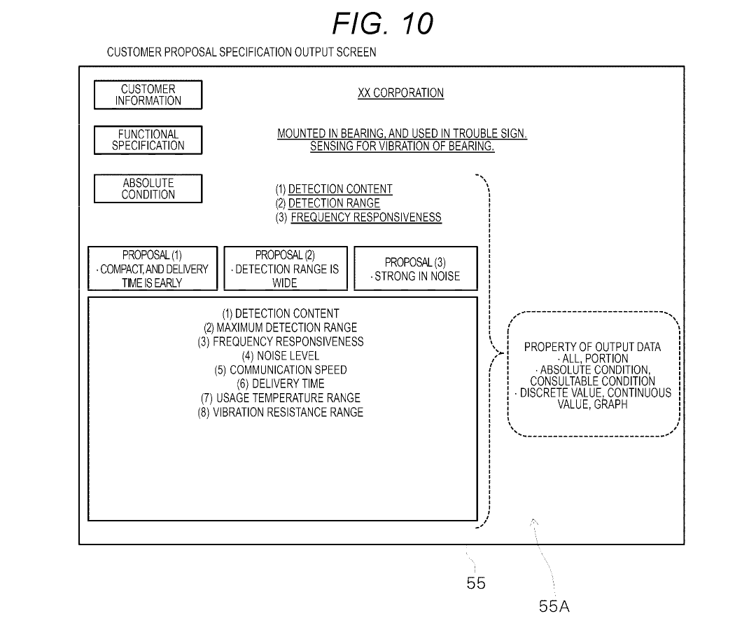

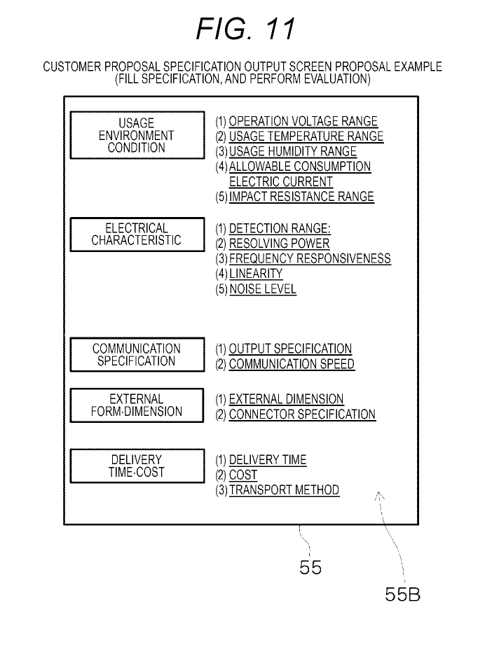

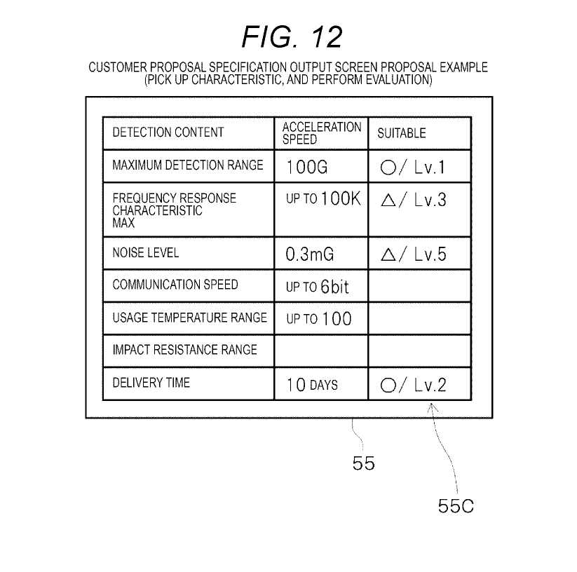

Therefore, the device design support apparatus 50 generates an output screen relating to the generated second device provisional specification. FIG. 10 is a diagram illustrating an example of an outline of the second device provisional specification which is presented to the customer according to Embodiment 1 of the present invention. FIG. 11 is a diagram illustrating an example of the details of the second device provisional specification according to Embodiment 1 of the present invention. FIG. 12 is a diagram illustrating an example of the evaluation of the device characteristic in the second device provisional specification according to Embodiment 1 of the present invention. For example, as illustrated in FIG. 10, the device specification generating portion 54 generates a device provisional specification outline list 55A by summarizing the outline of the second device provisional specification. For example, the device provisional specification outline list 55A respectively includes the columns for outputting “customer information”, “functional specification”, “absolute condition”, “proposal”, and “outline of device provisional specification”.

The device specification generating portion 54 outputs the customer name to the “customer information” column, based on the customer demand specification. The device specification generating portion 54 outputs the information relating to the function of the device, such as “mounted in bearing, and used in trouble sign. sensing for bearing vibration”, to the “functional specification” column, based on the customer demand specification. For example, the device specification generating portion 54 outputs the content such as a detection content, the detection range, or the frequency responsiveness, which is designated as an absolute condition, to the “absolute condition” column, based on the customer demand specification. For example, the device specification generating portion 54 outputs a proposal item relating to the second device provisional specification, to the “proposal” column. For example, as illustrated in FIG. 10, the device specification generating portion 54 outputs the proposal item such as the proposal relating to the size and the delivery time, the proposal relating to the detection range, or the proposal relating to the noise level. The device specification generating portion 54 outputs the outline of the second device provisional specification in accordance with the proposal item described above. For example, the device specification generating portion 54 outputs the device provisional specification which is excellent in size and delivery time, the device provisional specification which is excellent in detection range, and the device provisional specification which is excellent in noise level, to the columns for outputting the outline of the device provisional specification, in accordance with the proposal item.

For example, as illustrated in FIG. 11, the device specification generating portion 54 generates a device provisional specification detail list 55B illustrating the details of the generated second device provisional specification. For example, the device provisional specification detail list 55B includes the columns for outputting “usage environment condition”, “electrical characteristic”, “communication specification”, “external form⋅dimension”, and “delivery time⋅cost”. For example, the device specification generating portion 54 outputs the operation voltage range, the usage temperature range, the usage humidity range, the allowable consumption electric power, or the impact resistance range, to the “usage environment condition” column, based on the generated second device provisional specification. For example, the device specification generating portion 54 outputs the detection range, the resolving power, the frequency responsiveness, the linearity, or the noise level, to the “electrical characteristic” column, based on the generated second device provisional specification. For example, the device specification generating portion 54 outputs the communication specification or the communication speeds, to the “communication specification” column, based on the generated second device provisional specification. For example, the device specification generating portion 54 outputs the external dimension or the connector specification, to the “external form⋅dimension” column, based on the generated second device provisional specification. The device specification generating portion 54 outputs the delivery time, the cost, or the transport method, to the “delivery time⋅cost” column. The device specification generating portion 54 generates the device provisional specification detail list 55B, regarding each of the plurality of generated device provisional specifications.

For example, as illustrated in FIG. 12, the device specification generating portion 54 generates a device provisional specification evaluation list 55C illustrating the evaluation result of the device characteristic of the generated second device provisional specification. For example, in an “evaluation item” column of the device provisional specification evaluation list 55C, the device characteristics such as the detection content, the maximum detection range, a frequency response characteristic (MAX), the noise level, the communication speed, the usage temperature range, the vibration resistance range, and the delivery time are listed. The device specification generating portion 54 outputs the content of the generated second device provisional specification per evaluation item, to the “device provisional specification” column. The device specification generating portion 54 outputs the evaluation result per evaluation items, to the “evaluation result” column. In a case where the generated device provisional specification sufficiently satisfies the customer demand specification (first device provisional specification), the device specification generating portion 54 outputs the information indicating that the evaluation is high, for example, “suitable”, “O”, “Lv. 1”, or “Lv. 2”, to the “evaluation result” column. In a case where the generated device provisional specification does satisfies the customer demand specification (first device provisional specification), but the degree thereof is not necessarily sufficient, the device specification generating portion 54 outputs the information indicating that the evaluation is low, for example, “Δ”, “Lv. 3”, or “Lv. 5”, to the “evaluation result” column. The device specification generating portion 54 generates the device provisional specification evaluation list 55C, regarding each of the plurality of generated device provisional specifications.

In step S90 of FIG. 5, the device design support apparatus 50 outputs the generated second device provisional specification to the customer terminal 10. For example, the device specification generating portion outputs the device provisional specification outline list 55A, the device provisional specification detail list 55B, and the device provisional specification evaluation list 55C which are generated based on the second device provisional specification, to the customer terminal 10, through the data input-output portion 51 and the network 30. Thereby, the device design support apparatus 50 presents the generated second device provisional specification to the customer, and performs a negotiation with the customer based on the second device provisional specification. That is, the customer performs the change or an addition of the specification, based on the contents of the device provisional specification outline list 55A, the device provisional specification detail list 55B, and the device provisional specification evaluation list 55C, and the content of the negotiation with a maker. Here, for example, the addition of the specification means that the customer adds the specification to the item (which becomes a blank column) in which the device specification is not been represented by the customer demand specification or the second device provisional specification. For example, the customer inputs the content of the change or the addition of the specification, from the input operation portion 13 of the customer terminal 10, and outputs the input content to the device design support apparatus 50. If there is no change or addition of the specification, the customer may input the purport thereof, and may output the purport thereof to the device design support apparatus 50.

In step S100 of FIG. 5, the device design support apparatus 50 updates the second device provisional specification based on the content of the change or the addition of the specification which is output from the customer terminal 10, and generates the third device provisional specification. For example, the data input-output portion 51 receives the input of the content of the change or the addition of the specification which is output from the customer terminal 10. Therefore, for example, the data input-output portion 51 outputs the received content of the change or the addition of the specification to the device specification generating portion 54. The device specification generating portion updates the second device provisional specification based on the content of the change or the addition of the specification, and generates the third device provisional specification. If there is no change or addition of the specification from the customer, the third device provisional specification is equivalent to the second device provisional specification. The device specification generating portion 54 outputs the generated third device provisional specification, for example, to the database generating portion 52. The device specification generating portion 54 may generate the device provisional specification outline list, the device provisional specification detail list, and the device provisional specification evaluation list illustrated in FIGS. 10 to 12 which correspond to the third device provisional specification.

In step S110 of FIG. 5, the device design support apparatus 50 searches for the individual database DB31, DB32, or the like, and determines whether or not there is the device satisfying the third device provisional specification. For example, the database generating portion 52 searches for the individual database DB31, DB32, or the like, based on the third device provisional specification which is output from the device specification generating portion 54. In a case where it is not possible to extract the device model satisfying the third device provisional specification, the database generating portion 52 performs step S60 described above again. In step S60 of the second time, for example, the device specification generating portion 54 may generate a new evaluation factor combination by adding the evaluation factor. The device specification generating portion 54 may generate the new evaluation factor combination by changing the combination of the evaluation factors. On the contrary, in a case where it is possible to extract the device model satisfying the third device provisional specification, the database generating portion 52 performs step S120.

In step S120 of FIG. 5, the device design support apparatus 50 outputs the generated third device provisional specification to the customer terminal 10. For example, the device specification generating portion outputs the third device provisional specification (including a third device provisional specification list, for example) to the customer terminal 10, through the data input-output portion 51 and the network 30. In this manner, the device design support apparatus 50 proposes the third device provisional specification to the customer, and performs the negotiation with the customer. The customer refers to the proposed third device provisional specification, and supplements the content of the third device provisional specification to be the more suitable specification. For example, the customer inputs the supplement content of the third device provisional specification, from the input operation portion 13 of the customer terminal 10. Therefore, the customer terminal 10 outputs the input supplement content to the device design support apparatus 50.

In step S130 of FIG. 5, the device design support apparatus 50 generates the device fixed specification based on the supplement content which is output from the customer terminal 10. For example, the device specification generating portion 54 generates the device fixed specification, by updating the third device provisional specification based on the supplement content. The device specification generating portion 54 outputs the generated device fixed specification, for example, to the database generating portion 52.

The device design support apparatus 50 generates the device fixed specification database based on the device fixed specification. For example, the database generating portion 52 searches for the individual database DB31, DB32, or the like, based on the device fixed specification which is output from the device specification generating portion 54, and extracts the device model satisfying the device fixed specification. Therefore, the database generating portion 52 generates a device fixed specification database DB40 relating to the extracted device, which is configured with the device structure parameter, the device characteristic parameter, and the like. By performing steps S10 to S140, the device specification is determined.

In step S110 described above, in a case where it is possible to extract the device model satisfying the third device provisional specification, the database generating portion 52 may directly proceed to step S130, without performing step S120. In this case, the database generating portion 52 may set the third device provisional specification as a device fixed specification, and may generate the fixed specification database DB40 based on the device fixed specification.

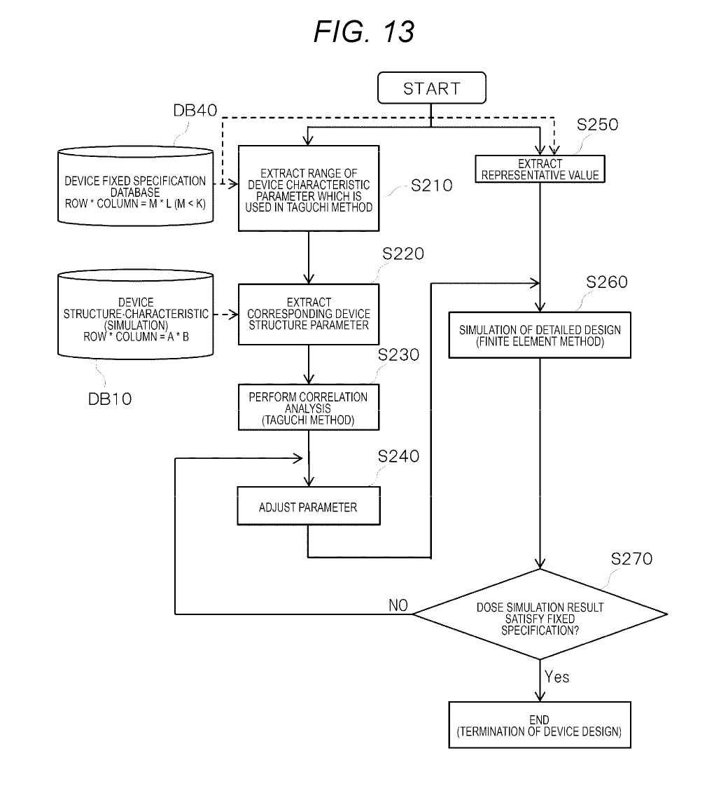

Next, the simulation process will be described. In the simulation process, in a case where the variation occurs in the device structure parameter due to the manufacturing variation, the simulation is performed in order to determine whether or not the variation of the device characteristic parameter is within the allowable range of the device fixed specification before the manufacturing of the device is started by performing the simulation. In this manner, the simulation that is performed in order to determine in advance whether or not the variation of the device characteristic parameter is within the allowable range with respect to the specification of the device before the start of the manufacturing, is generally referred to as Taguchi Method, quality engineering, or the like. FIG. 13 is a flowchart illustrating an example of the simulation process according to the Embodiment 1 of the present invention. In the simulation process, each processing of steps S210 to S270 illustrated in FIG. 13, is performed.

In step S210, the device design support apparatus 50 extracts the device characteristic parameter which is necessary for performing the simulation, from the device fixed specification database DB40. For example, the device specification generating portion 54 extracts the device characteristic parameter of the allowable range in which the variation is within the allowable range with respect to the device fixed specification, from the device fixed specification database DB40. For example, the device characteristic parameter of the allowable range is a value (discrete value or continuous value) having a predetermined range.

In step S220, the device design support apparatus 50 extracts the device structure parameter which is necessary for performing the simulation, from the first database DB10, based on the device characteristic parameter which is extracted in step S210. For example, the device specification generating portion 54 extracts the device structure parameter of the allowable range corresponding to the device characteristic parameter of the allowable range, in which the variation is within the allowable range with respect to the device fixed specification, from the first database DB10. The device structure parameter of the allowable range is the same as the device characteristic parameter of the allowable range, and is the value (discrete value or continuous value) having a predetermined range, for example.

In step S230, the device design support apparatus 50 performs a correlation analysis between the device characteristic parameter which is extracted in step S210 and the device structure parameter which is extracted in step S220. For example, the device specification generating portion 54 analyzes a variation range of the device characteristic parameter in a case where the device structure parameter varies within the variation allowable range, based on the device characteristic parameter of the allowable range and the device structure parameter of the allowable range. The device specification generating portion 54 analyzes the variation range of the device characteristic parameter with respect to each item of the device characteristic.

In step S240, the device design support apparatus 50 adjusts the device characteristic parameter which is extracted in step S210 and the device structure parameter which is extracted in step S220, based on a result of the correlation analysis. As a result of the correlation analysis, in a case where the device characteristic parameter varies in excess of the range of the device characteristic parameter of the allowable range, with respect to the device structure parameter of the allowable range, for example, the device specification generating portion 54 performs the narrowing-down of the range of the device structure parameter of the allowable range, such that the variation range of the device characteristic parameter belongs to the device characteristic parameter of the allowable range.

On the contrary, as a result of the correlation analysis, in a case where the device characteristic parameter varies within the range of the device characteristic parameter of the allowable, with respect to the device structure parameter of the allowable range, for example, the device specification generating portion 54 extends the range of the device structure parameter of the allowable range, within the range where the variation range of the device characteristic parameter belongs to the device characteristic parameter of the allowable range. Alternatively, for example, the device specification generating portion 54 performs the narrowing-down of the range of the device characteristic parameter of the allowable range, such that the variation range of the device characteristic parameter belongs to the range of the device characteristic parameter of the allowable range.

In step S250, the device design support apparatus 50 extracts a representative value of each item of the device fixed specification, based on the device fixed specification database DB40. For example, the device specification generating portion 54 searches for the device fixed specification database DB40, and extracts the representative value of each item of the device fixed specification from the plurality of device models satisfying the device fixed specification. Alternatively, for example, the device specification generating portion 54 may extract the representative value of each item, by extracting the parameters of each item from the plurality of device models, and calculating an average value of the parameters.

In step S260, the device design support apparatus 50 performs the simulation, based on the device characteristic parameter and the device structure parameter which are adjusted in step S240, and the representative value of each item. In detail, in step S260, the device design support apparatus 50 performs the simulation that is more detailed than the correlation analysis performed in step S230. For example, the device specification generating portion 54 uses the device characteristic parameter of the allowable range and the device structure parameter of the allowable range which are adjusted in step S240, and the representative value of the device fixed specification which is extracted in step S250, and performs the simulation of the finite element method or the like, for example. The device specification generating portion 54 calculates, for example, the variation range of device characteristic parameter, by the simulation.

In step S270, the device design support apparatus 50 determines whether or not the device characteristic parameter of the device model configuring the device fixed specification database DB40 satisfies the device fixed specification, based on the result of the simulation. For example, based on the result of the simulation, the device specification generating portion 54 determines whether or not the variation range of the device characteristic parameter of the device model configuring the device fixed specification database DB40 belong to the range of the device characteristic parameter of the allowable range. For example, in a case where the variation range of the device characteristic parameter does not belong to the range of the device characteristic parameter of the allowable range, the device specification generating portion 54 determines that the device configuring the device fixed specification database DB40 does not satisfy the device fixed specification, and performs step S240 again. In step S240 of the second time, for example, the device specification generating portion 54 performs readjustments of the device characteristic parameter of the allowable range, and the device structure parameter of the allowable range, to which the simulation result in step S260 is reflected.

On the contrary, for example, in a case where the variation range of the device characteristic parameter belongs to the range of the device characteristic parameter of the allowable range, the device specification generating portion 54 determines that the device configuring the device fixed specification database DB40 belongs to the allowable range of the device fixed specification, and the simulation process is completed. By performing the process, the device design is completed. Due to the simulation process, the device is manufactured, in accordance with the device model which is determined to belong to the allowable range of the device fixed specification.

### Effect by Embodiment 1

According to Embodiment 1, the database generating portion 52 generates the first database DB10 which is stored in the database storing portion 53, and the individual database (second database) DB31, DB32, or the like based the customer demand specification (first device provisional specification). The device specification generating portion 54 generates the second device provisional specification relating to the device based on the second database, receives the input of the change content of the second device provisional specification from the customer, and generates the device fixed specification of the device based on the second device provisional specification and the change content.

According to the configuration, even in a case where the device specification relating to a portion of items is not illustrated in the customer demand specification, the second device provisional specification satisfying the customer demand specification based on the individual database DB31, DB32, or the like, is presented to the customer. The customer corrects the second device provisional specification by the input of the change content. Therefore, the device specification generating portion 54 generates the device fixed specification while preventing the number of exchanges with the customer. Thereby, it is possible to early fix the device specification to which the intention of the customer is reflected.

According to the Embodiment 1, the device specification generating portion 54 selects the evaluation factor for cluster analysis based on the customer demand specification, and performs the cluster analysis per evaluation factor with respect to the first intermediate database DB20. The device specification generating portion 54 performs the weighting of the evaluation factor based on the result of the cluster analysis, and selects the evaluation factor of which priority is high based on the weighting. Therefore, the database generating portion 52 generates the individual databases DB31, DB32, or the like based on the evaluation factor of which priority is high.

According to the configuration, since the second device provisional specification that considers the evaluation factor of which priority is high to be important is generated, the device fixed specification that is excellent in performance relating to the evaluation factor of which priority is high, is generated. In a case where the priority of the evaluation factor is selected based on the intention of the customer, the device fixed specification to which the intention of the customer is reflected, is generated.

According to Embodiment 1, the device specification generating portion 54 generates the evaluation factor combination by combining the plurality of evaluation factors of which priorities are high. Therefore, the database generating portion 52 generates the individual databases DB31, DB32, or the like based on the evaluation factor combination which is configured with the plurality of evaluation factors.

According to the configuration, since the second device specification that considers the plurality of selected evaluation factors to be important is generated, the device fixed specification that is excellent in performance relating to the plurality of evaluation factors of which priorities are high, is generated.

According to the Embodiment 1, the device specification generating portion 54 generates the device provisional specification outline list 55A, the device provisional specification detail list 55B, and the device provisional specification evaluation list 55C based on the second device provisional specification, and outputs the generated device provisional specification outline list 55A, the generated device provisional specification detail list 55B, and the generated device provisional specification evaluation list 55C as a second device provisional specification.

According to the configuration, since the device provisional specification outline list 55A, the device provisional specification detail list 55B, and the device provisional specification evaluation list 55C relating to the second device provisional specification are presented to the customer, it is possible to comprehend the second device provisional specification to be more detailed, by the customer. Thereby, it is possible to output the more suitable change content to the device design support apparatus 50, by the customer, and the device fixed specification of which quality is improved, is generated.

According to Embodiment 1, the device specification generating portion 54 generates the third device provisional specification based on the second device provisional specification, and the change content from the customer, and presents the third device provisional specification to the customer. Therefore, the device specification generating portion 54 receives the input of the supplement content relating to the third device provisional specification from the customer, and generates the device fixed specification based on the third device provisional specification and the supplement content.

According to the configuration, since the correction of the device provisional specification is performed again by the customer, the device fixed specification to which the intention of the customer is more suitably reflected, is generated. Since a long-time period is not necessary for the generation of the third device provisional specification from the second device provisional specification, it is possible to prevent the extension of the period until the device fixed specification is generated.

According to Embodiment 1, the database generating portion 52 generate the device fixed specification database DB40, by performing the narrowing-down with respect to the individual database DB31, DB32, or the like, based on the device fixed specification.

According to the configuration, since the device model satisfying the device fixed specification is extracted, the extracting of the parameter becomes easy in the simulation after the device fixed specification is generated.

According to the Embodiment 1, the device specification generating portion 54 determines whether or not the variation range of the device characteristic parameter is within the allowable range of the device fixed specification, by performing the simulation, in a case where the variation occurs in the device structure parameter due to the manufacturing variation, by a device fixed specification generating portion.

According to the configuration, since the variation range of the device characteristic with respect to the manufacturing variation of the device is predicted in advance, opportunities for fitting or redesigning of the device specification after the manufacturing of the device, are prevented.

According to Embodiment 1, the device specification generating portion 54 extracts the device characteristic parameter for performing the simulation, from the device fixed specification database DB40, and extracts the device structure parameter for performing the simulation from the first database DB10, based on the extracted device characteristic parameter. Therefore, the device specification generating portion 54 performs the correlation analysis between the extracted device characteristic parameter and the extracted device structure parameter, and adjusts the extracted device characteristic parameter and the extracted device structure parameter, based on the result of the correlation analysis. Therefore, the device specification generating portion 54 extracts the representative value of the device fixed specification, based on the device fixed specification database DB40, and performs the simulation based on the adjusted device characteristic parameter, the adjusted device structure parameter, and the representative value. Therefore, the device specification generating portion 54 determines whether or not the device characteristic parameter of the device model configuring the device fixed specification database DB40 is within the allowable range of the device fixed specification, based on the result of the simulation.

According to the configuration, since the variation range of the device characteristic with respect to the manufacturing variation of the device is predicted in more detail, the opportunities for fitting or redesigning of the device specification after the manufacturing of the device, are prevented more than ever.

According to Embodiment 1, in a case where the variation range of the device characteristic parameter of the device model configuring the device fixed specification database DB40 does not belong to the allowable range of the device fixed specification, based on the result of the simulation, the device specification generating portion 54 adjusts the extracted device characteristic parameter and the extracted device structure parameter again.

According to the configuration, since the device model that does not belong to the variation range of the device characteristic parameter in the device fixed specification is excluded, accuracy of the simulation is further improved, and the quality of the device is stabilized.

According to Embodiment 1, the device design support apparatus 50 and the customer terminal 10 are connected to each other through the network 30. According to the configuration, since the input or the output is performed between the device design support apparatus 50 and the customer terminal 10 through the network 30, it is possible to use the device design support system, even if the customer is separated from the device design support apparatus 50.

### Embodiment 2

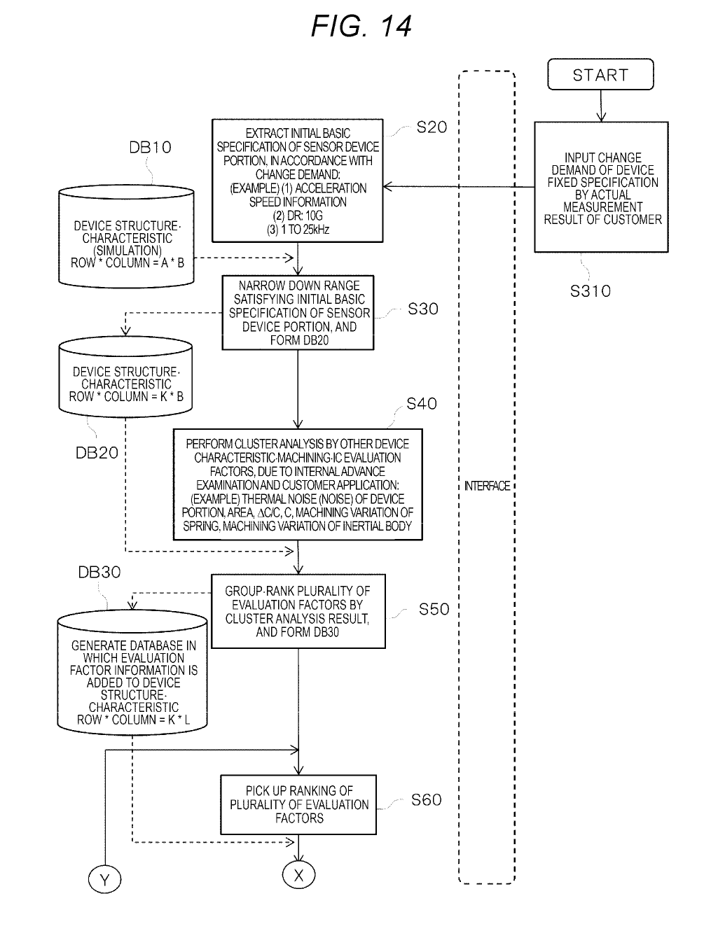

Next, Embodiment 2 of the present invention will be described. FIG. 14 is a flowchart illustrating an example of a process of determining a new device fixed specification according to Embodiment 2 of the present invention. In the process of determining the new device fixed specification, the new device fixed specification is generated, by performing each processing according to steps S70 to S130 illustrated in FIG. 5, after performing each processing according to steps S310, S20 to S60 illustrated in FIG. 14.

In step S310, the device specification generating portion 54 receives the input of the change demand of the device fixed specification. For example, the customer performs a test of the device which is manufactured by the device fixed specification. Therefore, the customer determines the content of the change demand of the device fixed specification, based on a test result of the device. Therefore, for example, the customer inputs the determined change content of the device fixed specification, from the input operation portion 13 of the customer terminal 10. The customer terminal 10 outputs the input change demand of the device fixed specification to the device design support apparatus 50 through the data input-output portion 11 and the network 30.

In step S20, the data input-output portion 51 receives the device specification change demand which is output from the customer terminal 10. The data input-output portion 51 outputs the input device specification change demand, for example, to the device specification generating portion 54. Therefore, for example, the device specification generating portion 54 extracts the sensor initial basic specification, the IC initial basic specification, or the package initial basic specification, based on the device specification change demand.

In steps S30 to S130, the processing which is the same as that of Embodiment 1 described above is performed, based on the device specification change demand. Here, the details of each processing according to steps S30 to S130 will be omitted. After the new device fixed specification is generated, the simulation process illustrated in FIG. 13 is performed.

According to Embodiment 2, the device specification generating portion 54 receives the input of the device specification change demand from the customer based on an actual measurement result of the device which is manufactured by the device fixed specification, and generates the new device fixed specification based on the device fixed specification and the device specification change demand.

According to the configuration, since the new device fixed specification is generated based on the actual measurement result, the device fixed specification of which the quality is further improved is generated. Thereby, the device of which the quality is further improved, is provided.

### Embodiment 3

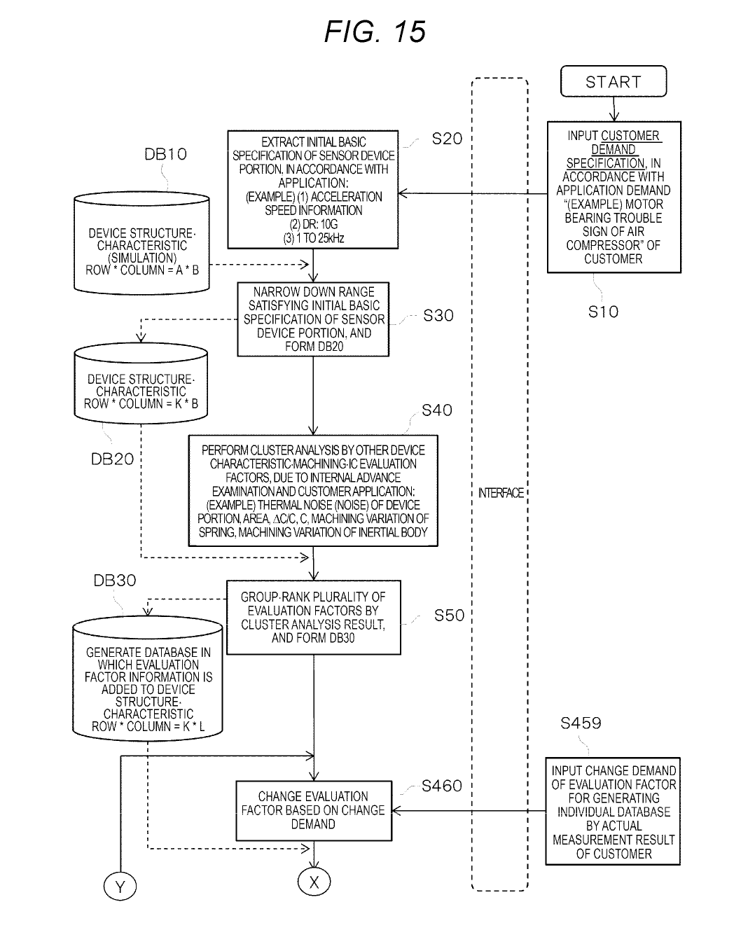

Next, Embodiment 3 of the present invention will be described. FIG. 15 is a flowchart illustrating an example of the process of determining a new device fixed specification according to Embodiment 3 of the present invention. In the process of determining the new device fixed specification, the new device fixed specification is generated, by performing each processing according to steps S70 to S130 illustrated in FIG. 5, after performing each processing according to steps S10 to S50, S459, and S460 to illustrated in FIG. 15.

In step S459, the device specification generating portion 54 receives the input of the change demand of the evaluation factor. For example, the customer performs the test of the device which is manufactured by the device fixed specification. Therefore, the customer determines the content of the change demand of the evaluation factor, based on the test result of the device. Therefore, for example, the customer inputs the determined change content of the evaluation factor, from the input operation portion 13 of the customer terminal 10. The customer terminal 10 outputs the input change demand of the evaluation factor to the device design support apparatus 50 through the data input-output portion 11 and the network 30.

In step S460, the data input-output portion 51 receives the input of the change demand of the evaluation factor which is output from the customer terminal 10. The data input-output portion 51 outputs the input change demand of the evaluation factor, for example, to the device specification generating portion 54. Therefore, the device specification generating portion 54 changes the evaluation factor for cluster analysis based on the change demand of the evaluation factor. For example, the device specification generating portion 54 may add a new evaluation factor based on the input change demand of the evaluation factor, or may replace a portion or all of the evaluation factors with a new evaluation factor. Therefore, the device specification generating portion 54 generates the plurality of evaluation factor combinations for individual database described later again, based on the changed evaluation factor.

In steps S10 to S50, and steps S70 to S130, the processing which is the same as that of Embodiment 1 described above is performed, based on the change demand of the evaluation factor. Here, the details of each processing according to steps S10 to S50, and steps S70 to S130 will be omitted. After the new device fixed specification is generated, the simulation process illustrated in FIG. 13 is performed.

In Embodiment 3, for example, it is regardless that the processing according to steps S10 to S50 is not performed. For example, if the change demand of the evaluation factor is output from the customer terminal 10 in step S459, the device specification generating portion may change the evaluation factor, for example, by referring to the database or the like which is stored in the database storing portion 53 or the server 90, in step S460. Thereby, since there is no need to perform the input of the customer demand specification again by the customer, the terminal operation by the customer is reduced. The period for generating of the further device fixed specification is shortened.

According to Embodiment 3, the device specification generating portion 54 receives the input of the change demand of the evaluation factor from the customer based on the actual measurement result of the device which is manufactured by the device fixed specification, and changes the evaluation factor based on the change demand.

According to the configuration, since the new device fixed specification is generated based on the test result, the device fixed specification of which the quality is further improved is generated. Thereby, the device of which the quality is further improved, is provided.

Hitherto, the present invention made by the inventors is specifically described based on the embodiments, but the present invention is not limited to the embodiments described above, and may be variously modified with the scope without departing from the gist thereof, regardless to say.

The present invention is not limited to the embodiments described above, and includes various modification examples. For example, the embodiments described above are described in detail in order to describe the present invention in an easily understood manner, and are not necessarily limited to include all of the described configurations.

It is possible to replace a portion of the configuration of a certain embodiment with the configurations of other embodiments, and it is possible to add the configurations of other embodiments to the configuration of a certain embodiment. It is possible to add, delete, or replace other configurations, with respect to a portion of the configuration of each embodiment. Each member or the relative size thereof described in the drawings, are simplified and idealized in order to describe the present invention in an easily understood manner, and there is a case where the more complicated shape is made on the mounting.

Hereinafter, preferred main aspects of the present invention will be appended.

### [Appendix 1]

A device design support method including,

in which a device design support apparatus includes
a data input-output portion that performs input-output of data,
a database storing portion that stores a database configured with a plurality of device models relating to a device,
a database generating portion that generates the database, and
a device specification generating portion that generates a device specification of the device,

receiving an input of a first device provisional specification relating to the device, by the data input-output portion,

generating a second database based on a first database stored in the database storing portion and the first device provisional specification, by the database generating portion,

generating a second device provisional specification relating to the device based on the second database, by the device specification generating portion,

outputting the generated second device provisional specification through the data input-output portion, by the device specification generating portion,

receiving the input of a change content of the second device provisional specification, by the device specification generating portion, and

generating a device fixed specification of the device based on the second device provisional specification and the change content, by the device specification generating portion.

### [Appendix 2]

The device design support method according to Appendix 1, further including,

generating a first intermediate database by performing narrowing-down with respect to the first database, based on the first device provisional specification, by the database generating portion,

selecting an evaluation factor for cluster analysis based on the first device provisional specification, by the device specification generating portion,

performing a cluster analysis per evaluation factor with respect to the first intermediate database, by the device specification generating portion,

performing weighting of the evaluation factor based on a result of the cluster analysis, by the device specification generating portion,

selecting the evaluation factor of which priority is high based on the weighting, by the device specification generating portion, and

generating an individual database based on the evaluation factor of which priority is high, as the second database, by the database generating portion.

### [Appendix 3]

The device design support method according to Appendix 2, further including,

generating an evaluation factor combination by combining a plurality of evaluation factors of which priorities are high, by the device specification generating portion, and

generating an individual database based on the evaluation factor combination, as the second database, by the database generating portion.

### [Appendix 4]

The device design support method according to Appendix 1, further including,

generating a device provisional specification outline list, a device provisional specification detail list, and a device provisional specification evaluation list based on the second device provisional specification, by the device specification generating portion, and

outputting the generated device provisional specification outline list, the generated device provisional specification detail list, and the generated device provisional specification evaluation list, as the second device provisional specification, by the device specification generating portion.

### [Appendix 5]

The device design support method according to Appendix 1, further including,

generating a third device provisional specification based on the second device provisional specification and the change content, by the device specification generating portion,

outputting the third device provisional specification through the data input-output portion, and receiving the input of a supplement content of the third device provisional specification, by the device specification generating portion, and

generating the device fixed specification based on the third device provisional specification and the supplement content, by the device specification generating portion.

### [Appendix 6]

The device design support method according to Appendix 1, further including,

generating a device fixed specification database by performing narrowing-down with respect to the second database, based on the device fixed specification, by the database generating portion.

[Appendix 7]

The device design support method according to Appendix 6, further including,

in which the device model is configured with a device structure parameter relating to a structure of the device, and a device characteristic parameter relating to a characteristic of the device,

determining whether or not variation of the device characteristic parameter is within an allowable range of the device fixed specification, by performing simulation, in a case where variation occurs in the device structure parameter due to manufacturing variation, by the device specification generating portion.

### [Appendix 8]

The device design support method according to Appendix 7, further including,

extracting the device characteristic parameter for performing the simulation, from the device fixed specification database, by the device specification generating portion,

extracting the device structure parameter for performing the simulation from the first database, based on the extracted device characteristic parameter, by the device specification generating portion,

performing a correlation analysis between the extracted device characteristic parameter and the extracted device structure parameter, by the device specification generating portion,

adjusting the extracted device characteristic parameter and the extracted device structure parameter, based on a result of the correlation analysis, by the device specification generating portion,

extracting a representative value of the device fixed specification, based on the device fixed specification database, by the device specification generating portion,

performing the simulation, based on the adjusted device characteristic parameter, the adjusted device structure parameter, and the representative value, by the device specification generating portion, and

determining whether or not the device characteristic parameter of the device model configuring the device fixed specification database is within the allowable range of the device fixed specification, based on a result of the simulation, by the device specification generating portion.

What is claimed is:

1. A device design support apparatus comprising:
a data input-output portion that performs input-output of data;
a database storing portion that stores a database configured with a plurality of device models relating to a device;
a database generating portion that generates the database; and
a device specification generating portion that generates a device specification of the device,
wherein the data input-output portion receives an input of a first device provisional specification relating to the device,
the database generating portion generates a second database based on a first database stored in the database storing portion and the first device provisional specification, and
the device specification generating portion generates a second device provisional specification relating to the device based on the second database, outputs the generated second device provisional specification through the data input-output portion, receives the input of a change content of the second device provisional specification, and generates a device fixed specification of the device based on the second device provisional specification and the change content.

2. The device design support apparatus according to claim 1,
wherein the database generating portion generates a first intermediate database by performing narrowing-down with respect to the first database, based on the first device provisional specification,
the device specification generating portion selects an evaluation factor for cluster analysis based on the first device provisional specification, performs a cluster analysis per evaluation factor with respect to the first intermediate database, performs weighting of the evaluation factor based on a result of the cluster analysis, and selects the evaluation factor of which priority is high based on the weighting, and
the database generating portion generates an individual database based on the evaluation factor of which priority is high, as the second database.

3. The device design support apparatus according to claim 2,
wherein the device specification generating portion generates an evaluation factor combination by combining a plurality of evaluation factors of which priorities are high, and
the database generating portion generates an individual database based on the evaluation factor combination, as the second database.

4. The device design support apparatus according to claim 1,
wherein the device specification generating portion generates a device provisional specification outline list, a device provisional specification detail list, and a device provisional specification evaluation list based on the second device provisional specification, and outputs the generated device provisional specification outline list, the generated device provisional specification detail list, and the generated device provisional specification evaluation list, as the second device provisional specification.

5. The device design support apparatus according to claim 1,
wherein the device specification generating portion generates a third device provisional specification based on the second device provisional specification and the change content, outputs the third device provisional specification through the data input-output portion, receives the input of a supplement content of the third device provisional specification, and generates the device fixed specification based on the third device provisional specification and the supplement content.

6. The device design support apparatus according to claim 1,
wherein the database generating portion generates a device fixed specification database by performing narrowing-down with respect to the second database, based on the device fixed specification.

7. The device design support apparatus according to claim 6,
wherein the device model is configured with a device structure parameter relating to a structure of the device, and a device characteristic parameter relating to a characteristic of the device, and
the device specification generating portion determines whether or not variation of the device characteristic parameter is within an allowable range of the device fixed specification, by performing simulation, in a case where variation occurs in the device structure parameter due to manufacturing variation.

8. The device design support apparatus according to claim 7,
wherein the device specification generating portion extracts the device characteristic parameter for performing the simulation, from the device fixed specification database, extracts the device structure parameter for performing the simulation from the first database, based on the extracted device characteristic parameter, performs a correlation analysis between the extracted device characteristic parameter and the extracted device structure parameter, adjusts the extracted device characteristic parameter and the extracted device structure parameter, based on a result of the correlation analysis, extracts a representative value of the device fixed specification, based on the device fixed specification database, performs the simulation, based on the adjusted device characteristic parameter, the adjusted device structure parameter, and the representative value, and determines whether or not the device characteristic parameter of the device model configuring the device fixed specification database is within the allowable range of the device fixed specification, based on a result of the simulation.

9. A device design support system, comprising:
a device design support apparatus including
a data input-output portion that performs input-output of data,
a database storing portion that stores a database configured with a plurality of device model parameters relating to a device,
a database generating portion that generates the database, and
a device specification generating portion that generates a device specification of the device; and
a customer terminal including
a customer side data input-output portion that performs input-output of data, and
an input operation portion that performs an input operation by a customer,
wherein the customer terminal outputs a first device provisional specification input from the input operation portion, to the device design support apparatus through the customer side data input-output portion,
the device design support apparatus receives an input of the first device provisional specification, through the data input-output portion,
the database generating portion generates a second database based on a first database stored in the database storing portion and the first device provisional specification,
the device specification generating portion generates a second device provisional specification relating to the device based on the second database, and outputs the generated second device provisional specification to the customer terminal, through the data input-output portion,
the customer terminal outputs a change content of the second device provisional specification input from the input operation portion, to the device design support apparatus through the customer side data input-output portion,
the device design support apparatus receives the input of the change content, through the data input-output portion, and
the device specification generating portion generates a device fixed specification of the device based on the second device provisional specification and the change content.

10. The device design support system according to claim 9,
wherein the device specification generating portion generates a third device provisional specification based on the second device provisional specification and the change content, and outputs the third device provisional specification to the customer terminal through the data input-output portion,
the customer terminal outputs a supplement content of the third device provisional specification input from the input operation portion, to the device design support apparatus through the customer side data input-output portion,
the device design support apparatus receives an input of the supplement content, through the data input-output portion, and
the device specification generating portion generates the device fixed specification based on the third device provisional specification and the supplement content.

11. The device design support system according to claim 9,
wherein the device specification generating portion generates a device provisional specification outline list, a device provisional specification detail list, and a device provisional specification evaluation list based on the second device provisional specification, and outputs the generated device provisional specification outline list, the generated device provisional specification detail list, and the generated device provisional specification evaluation list, as the second device provisional specification, to the customer terminal through the data input-output portion.

12. The device design support system according to claim 11, further comprising:
a network,
wherein the device design support apparatus and the customer terminal are connected to each other through the network.

13. A device design support method of a device design support apparatus,
the apparatus including
a data input-output portion that performs input-output of data,
a database storing portion that stores a database configured with a plurality of device models relating to a device,
a database generating portion that generates the database, and
a device specification generating portion that generates a device specification of the device,
the method comprising:
receiving an input of a first device provisional specification relating to the device, by the data input-output portion;
generating a second database based on a first database stored in the database storing portion and the first device provisional specification, by the database generating portion;
generating a second device provisional specification relating to the device based on the second database, by the device specification generating portion;
outputting the generated second device provisional specification through the data input-output portion, by the device specification generating portion;
receiving the input of a change content of the second device provisional specification, by the device specification generating portion; and
generating a device fixed specification of the device based on the second device provisional specification and the change content, by the device specification generating portion.

14. The device design support method according to claim 13, further comprising:
receiving an input of a change demand of the device fixed specification which is determined based on a test result of the device manufactured by the device fixed specification, by the device specification generating portion; and
generating a new device fixed specification based on the device fixed specification and the change demand, by the device specification generating portion.

15. The device design support method according to claim 13, further comprising:
generating a first intermediate database by performing narrowing-down with respect to the first database, based on the first device provisional specification, by the database generating portion;
selecting an evaluation factor for cluster analysis based on the first device provisional specification, by the device specification generating portion;
performing a cluster analysis per evaluation factor with respect to the first intermediate database, by the device specification generating portion;
performing weighting of the evaluation factor based on a result of the cluster analysis, by the device specification generating portion;
selecting the evaluation factor of which priority is high based on the weighting, by the device specification generating portion;
generating an individual database based on the evaluation factor of which priority is high, as the second database, by the database generating portion;
receiving an input of a change demand of the evaluation factor which is determined based on a test result of the device manufactured by the device fixed specification, by the device specification generating portion; and
changing the evaluation factor for cluster analysis based on the change demand, by the device specification generating portion.
